(19) United States
(12) Patent Application Publication
(10) Pub. No.: US 2005/0069859 A1
(43) Pub. Date: Mar. 31, 2005

(54) Patient communication apparatus and method

(76) Inventor: Gaye C. Cherry, North Little Rock, AR (US)

Correspondence Address: J. Charles Dougherty;Wright, Lindsey & Jennings LLP, Suite 2300, 200 Little Capitol Avenue, Little Rock, AR, 72201, US

(21) Appl. No.: 10/953,400

(22) Filed: Sep. 29, 2004

Related U.S. Application Data
(60) Provisional application No. 60/506,841, filed on Sep. 30, 2003.

(51) Int. Cl. B43L 1/00

(52) U.S. Cl. 434/416

(57) ABSTRACT

A method for communicating between patients and caregivers comprises the use of a chart that includes a pictographic symbol and a corresponding wording presented in multiple languages. The method allows for communication with non-verbal patients, as well as patients who are verbal but do not speak the same language as the caregiver, using only one chart. The chart allows the patient to answer simple questions, and further allows the caregiver to ask basic questions concerning such matters as patient condition and comfort. The chart may be implemented using a substrate and a stylus for selection of chart regions, or may be implemented as a display screen, including the use of a touchscreen.

This application claims the benefit of U.S. provisional patent application No. 60/506,841, entitled “Handy Reference Bilingual Medical Word/Picture Chart,” filed on Sep. 30, 2003.

### BACKGROUND OF THE INVENTION

The present invention relates to devices and methods for communication between patients and caregivers, and in particular to methods for communicating between patients and medical caregivers where the patient is non-verbal, the patient does not speak the same language as the caregiver, or both.

Patients resident in a hospital or other healthcare facility may be unable to communicate verbally with a caregiver for a variety of reasons. For example, a patient may depend upon a ventilator for life support, and thus be unable to speak because of the equipment that prevents the patient from speaking. It is known in the art to use printed charts to communicate with such non-verbal patients. Such charts are used in intensive care units, coronary intensive care units, surgical intensive care units, emergency care units, and other areas where non-verbal patients are often found. One commonly used chart is a simple sheet of paper that has a number of squares printed upon its surface. Each square contains both a pictographic symbol and a corresponding word. The squares each relate to a particular idea or communicative concept, generally related to a medical condition, a comfort requirement of the patient, or simple answers to common questions. One square, for example, may include the printed word “cold” and a graphic representation of a snowflake. Another square may include a symbol of a person with his hand to his throat, and the words “can't breathe.” A third square may contain a checkmark and the word “yes.” By pointing to one or more of the squares on the chart, a non-verbal patient may communicate with a medical caregiver in a simple fashion. Such communication may be of great importance to the patient's care in emergency situations. Even during non-emergency situations, however, the use of a communications chart will allow caregivers to provide a non-verbal patient with a higher quality of care.

While these communication charts have proven highly useful in both emergency and non-emergency patient care, the utility of such charts is diminished if the patient does not speak the language in which the printed words appear on the chart. In the United States in particular, the rapid rise in the Spanish-speaking population means that hospitals and other healthcare facilities receive Spanish-speaking patients but may not have a sufficient number of caregivers who speak Spanish. A non-English speaking patient admitted for emergency care will often need medical services before an interpreter is available. Rapid, efficient, and accurate communication with such a patient may be essential in order for the patient to receive the best possible treatment. The patient may have input that is vitally needed at an initial care stage, such as informing the caregivers that he or she has a particular allergy or pre-existing medical condition. In addition, an inability to communicate with caregivers in such a situation may create additional fears in such a patient, since the patient unable to communicate will effectively have no input into his or her treatment.

While patients who do not speak the language in which the chart is printed may be able to communicate by relying upon the graphics appearing on the chart alone, those graphics may in some cases be difficult to interpret without the addition of word comprehension. For example, on one popular chart used for patient communication as described above, the phrase “where am I?” is graphically represented only by a large question mark. Without the ability to read the words under this symbol, however, it is highly doubtful a patient could understand what this square is to be used for, and thus the patient would have difficulty communicating this message to medical caregivers. This problem is only compounded in the case of non-verbal patients, some of whom may have suffered traumatic injury or illness, and their ability to understand and interpret the chart may be diminished in any event. In this particular example, a patient whose condition was such that the question “where am I?” becomes appropriate may not be able to think with sufficient coherence to correctly guess the meaning of the “?” symbol on the chart.

The prior art does include some attempts to initiate multilingual communications with patients using visual aids. For example, U.S. Pat. No. 4,428,733 to Kumar-Misir teaches an information gathering system that asks a patient several medically related questions, using a common answer sheet but replaceable overlay question sheets matching the language spoken by the patient. Similarly, U.S. Pat. No. 4,604,063 to Gurmarnik teaches a method of asking the same question in a plurality of languages, with an alignment of the answers such that the answers are easy to interpret without regard to the language in which the question was read by the patient. Both of these patents teach methods for gathering specific information about a patient, but are not designed to allow the patient to communicate in a more free-form fashion with caregivers. In particular, since both of these patents teach methods that require responses to complex questions, neither is appropriate for use in intensive- or emergency-care situations where communications with a patient is often most critical.

What is desired then is a simple, inexpensive apparatus and method for communicating with non-verbal patients and those who may not speak the same language as that spoken by the patient's caregivers, and which may be utilized in intensive- or emergency-care situations. It would be particularly desirable to develop such an apparatus and method that may be applied with both non-verbal patients and verbal patients who speak a different language than the patient's caregivers, whereby the materials used in such apparatus and method are identical in either case for ease and simplicity of use.

### BRIEF SUMMARY OF THE INVENTION

The present invention is directed to an apparatus and method of communicating with both verbal and non-verbal patients that includes a chart with squares each containing a pictographic symbol, a corresponding word, and a translation of that word into at least one other language. So long as the patient can read at least one of the languages represented by the words appearing on the chart, the patient may use this chart and an associated stylus to communicate effectively with caregivers. The patient and caregiver need not speak the same language, but must only each speak one of the languages represented on the chart in order for the chart to fully facilitate communication between them. Such a chart may allow a patient to communicate important information to caregivers at the time of initial treatment when no interpreter is available. Even when such information is not relevant to life-saving treatment, some ability to communicate with caregivers in an emergency-care situation may allay some of the fears of the patient at a time when emotional comfort is of great significance.

Because the chart of the present invention utilizes both pictographic symbols and words in multiple languages, the chart may be utilized by verbal patients as well as non-verbal patients. The same chart may be used for non-verbal patients who speak the same language as the caregivers; verbal patients who speak a different language from the caregivers; and non-verbal patients who speak a different language from the caregivers. This is a significant advantage of the present invention since the caregivers need not keep track of different devices or devices capable of displaying multiple charts depending upon which situation is presented. More importantly, the caregivers need not waste potentially critical time in determining which chart is required, since only one chart provides communication in all circumstances. Once it is determined that the caregiver cannot communicate with the patient verbally, for whichever of the above-stated reasons, the same chart may be used to facilitate communications with the patient.

It is therefore an object of the present invention to provide for a simple, chart-based apparatus and method of communicating with non-verbal patients.

It is a further object of the present invention to provide for a simple, chart-based apparatus and method of communicating with verbal patients who do not speak the same language as the caregiver.

It is also an object of the present invention to provide for a simple, chart-based apparatus and method of communicating with non-verbal patients who do not speak the same language as the caregiver.

It is also an object of the present invention to provide for an apparatus and method of communicating with patients using a single chart regardless of whether the patient is non-verbal or does not speak the same language as the caregiver.

It is also an object of the present invention to provide for an apparatus and method of communicating with patients who cannot speak with the caregiver without requiring a determination of whether the patient is non-verbal or whether the patient does not speak the same language as the caregiver.

These and other features, objects and advantages of the present invention will become better understood from a consideration of the following detailed description of the preferred embodiments and appended claims in conjunction with the drawing as described following:

### BRIEF DESCRIPTION OF THE DRAWING

FIG. 1 is a depiction of a chart appearing on an apparatus for use in connection with a preferred embodiment of the present invention.

### DETAILED DESCRIPTION OF THE INVENTION

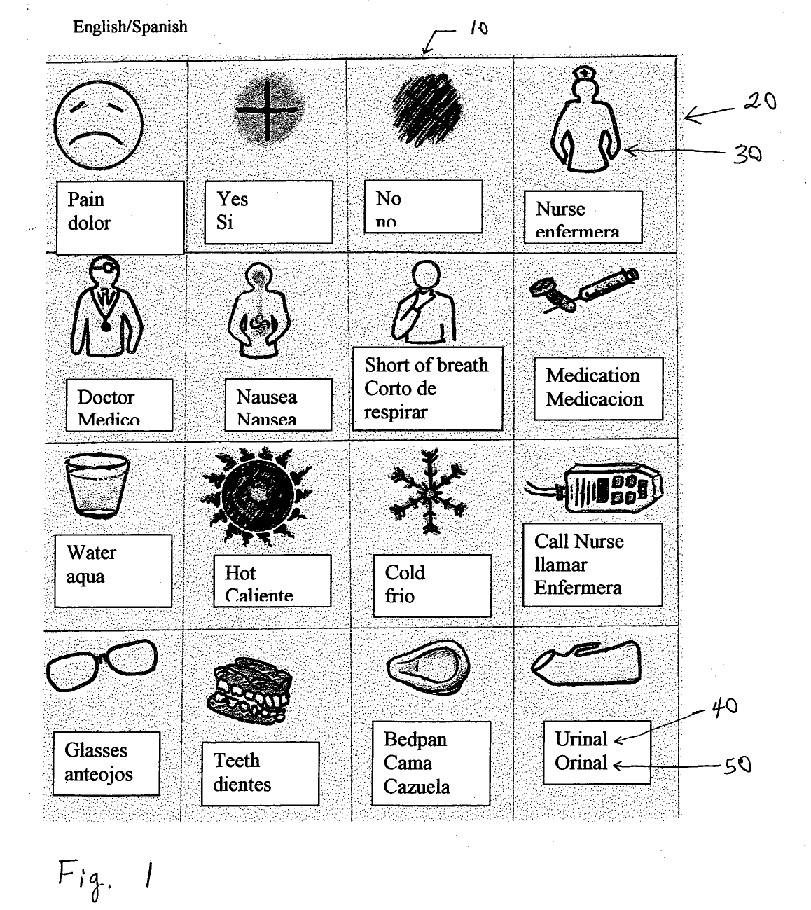

With reference to FIG. 1, a preferred embodiment of the present invention may be described. In a first example, a patient has been admitted to the intensive care unit of a hospital and is using a ventilator to assist his or her breathing. The patient is thus unable to communicate verbally in an effective manner. The caregiver may, however, provide the patient with a device that displays chart 10 of FIG. 1 in order to facilitate communication. The device upon which chart 10 is displayed may be, for example, a plastic sheet substrate or laminated card stock, or, alternatively, may be a display means associated with a computing device, such as a computer monitor, television screen, or other electronic display means.

The substrate upon which chart 10 is displayed will allow the patient to select a square 20 from the various squares presented on chart 10 in order to communicate a message to the caregiver. The selection process may depend upon the way in which the substrate is implemented. For example, in the embodiment of the invention in which the substrate is comprised of a plastic sheet upon which chart 10 is presented, the invention may comprise a stylus in the form of an erasable marker with which to indicate a selection. The stylus is preferably permanently attached to the substrate by means of a cord or other flexible means, such that the stylus cannot be misplaced and will be immediately available once the substrate is located. Other forms of stylus may be used in similar embodiments. In the embodiments in which chart 10 is presented on a computer monitor, television, laptop LCD screen, or other electronic display, a touchscreen input may be provided such that the patient may indicate the appropriate square 20 on chart 10 by simply touching the screen in the area defined by such square 20. Touchscreens of this type are known in the art. In this case, the patient's selection may be indicated by, for example, a change of color in the indicated square 20, or other visual indicia. Alternatively, the selection may be indicated by a communication sent remotely to a nurse station based on the selected square 20. In this embodiment, the communications between the patient and caregiver may take place remotely.

It may be seen that in each of these embodiments, various types of free-form communication are possible between the patient and caregiver. For example, the patient may respond to a question from the caregiver by pointing to the “yes” or “no” squares shown on chart 10. The question could be initiated either verbally or by the caregiver selecting a square 20 on chart 10 of the device. The patient may also initiate communications by selecting a square 20. For example, if the patient wishes to indicate that he or she is too hot, the patient may select the “hot” square 20 on chart 10.

It may be seen that chart 10 of the preferred embodiment, shown using both English and Spanish languages, may be used equally effectively by non-verbal patients whether the patient reads English, Spanish, or both languages. Each square 10 includes a pictographic symbol 30, in conjunction with a corresponding English word 40 and Spanish word 50. The patient can thus look to whichever word he or she may read more readily, together with the corresponding symbol, in order to more accurately identify the proper square 20 in communicating a message. The patient may thereby use chart 10 more quickly and effectively to communicate with a caregiver. The caregiver need not determine the patient's proficiency in any language prior to employing the device, so long as the patient reads one of the languages that appears on chart 10 of the device.

It may also be seen that chart 10 of the device may be used for communications with verbal patients when the patient and caregiver do not speak a common language. The method used in such case will follow the example above. The patient will select a square 20 from chart 10 based on the information he or she wishes to convey, and that information will be interpreted by the caregiver in the caregiver's own language. For example, in the case of a Spanish-speaking patient and English-speaking caregiver, the patient will select the appropriate square 20 based on a review of the pictographic image 30 and corresponding Spanish word 50, while the message will be interpreted by the caregiver using the pictographic image 30 and English word 40 of the square 20 that the patient has selected. The caregiver may communicate a message to the patient in a converse manner, selecting the appropriate square 20 on chart 10 in order to ask or answer a question.

Although the illustrated embodiment uses the English and Spanish languages, the invention is not so limited and may use any combination of languages as appropriate to the area in which the healthcare facility is located. Furthermore, the invention is not limited to the use of two languages; any number of languages may be used, such that each square 20 would includes a number of words or phrases corresponding to that number of languages implemented. In the electronic display embodiments of the invention, the device may be programmed to display any desired selection of languages.

In addition, alternative embodiments of the invention may utilize a chart 10 that allows the communication of less discrete forms of information. For example, a spectrum that allows a patient to communicate the patient's level of pain may be included, again with wording corresponding to each step in the spectrum in two or more languages. Each step on the spectrum would function as a square 20 that the patient may select.

The present invention has been described with reference to certain preferred and alternative embodiments that are intended to be exemplary only and not limiting to the full scope of the present invention as set forth in the appended claims.

1. A communication apparatus, comprising:
(a) a substrate;
(b) a chart appearing on said substrate, said chart comprising a plurality of regions, each said region comprising:
(i) a symbol;
(ii) a first wording corresponding to said symbol;
(iii) a second wording corresponding to said symbol, wherein said second wording is rendered in a different language than said first wording but is equivalent in meaning to said first wording; and
(c) a selection device operable to select one of said regions on said chart by contacting said selection device with said substrate.

2. The patient communication apparatus of claim 1, wherein said selection device comprises a stylus.

3. The patient communication apparatus of claim 2, further comprising a flexible retaining means wherein said stylus is attached to said substrate by said retaining means.

4. The patient communication apparatus of claim 2, wherein said substrate comprises a plastic sheet and said stylus comprises an erasable marker.

5. The patient communication apparatus of claim 1, wherein said substrate is a first electronic display.

6. The patient communication apparatus of claim 5, wherein said first electronic display operates to display visual indicia upon selection of one of said regions of said chart.

7. The patient communication apparatus of claim 5, wherein said first electronic display is touch-sensitive wherein touching one of said regions on said chart operates to select said region on said chart and display visual indicia.

8. The patient communication apparatus of claim 5, further comprising a second electronic display and a communications link communicatively connecting said first electronic display and said second electronic display.

9. The patient communication apparatus of claim 8, wherein said second electronic display operates to receive a signal from said first electronic display across said communications link and display indicia corresponding to a selected region on said first electronic display.

10. The patient communication apparatus of claim 9, wherein said first electronic display operates to receive a signal from said second electronic display across said communications link and display indicia corresponding to a selected region on said second electronic display.

11. A patient communication apparatus, comprising:
(a) a local electronic display; and
(b) a chart appearing on said local electronic display, said chart comprising a plurality of regions, each said region comprising:
(i) a symbol;
(ii) a first wording corresponding to said symbol;
(iii) a second wording corresponding to said symbol, wherein said second wording is rendered in a different language than said first wording but is equivalent in meaning to said first wording,
wherein said local electronic display operates to display visual indicia upon selection of one of said regions of said chart.

12. The patient communication apparatus of claim 11, wherein said local electronic display is touch-sensitive wherein touching one of said regions on said chart operates to select said region on said chart and display visual indicia.

13. The patient communication apparatus of claim 11, further comprising a remote electronic display and a communications link communicatively connecting said local electronic display and said remote electronic display.

14. The patient communication apparatus of claim 13, wherein said remote electronic display operates to receive a signal from said local electronic display across said communications link and display indicia corresponding to a selected region on said local electronic display.

15. The patient communication apparatus of claim 14, wherein said local electronic display operates to receive a signal from said remote electronic display across said communications link and display indicia corresponding to a selected region on said remote electronic display.

16. A method for communicating between a caregiver and a patient utilizing a communication device comprising a visual display screen, said method comprising the steps of:
(a) displaying on the screen a chart comprising a plurality of regions, each region comprising a symbol, a first wording corresponding to the symbol, and a second wording corresponding to the symbol, wherein the second wording is rendered in a different language than the first wording but is equivalent in meaning to the first wording;
(b) receiving a selection of a region on the chart by the patient or the caregiver; and
(c) responding to the selection of a region on the chart by the display of visual indicia.

17. The method for communicating between a caregiver and a patient of claim 16, wherein said screen is a touchscreen display, and wherein said receiving step is performed by means of the patient or the caregiver touching a region on the chart.

18. The method of communicating between a caregiver and a patient of claim 16, wherein the display of visual indicia in said responding step comprises the changing of the color of display for the region on the chart selected by the patient or the caregiver.
